(19) United States
(12) Patent Application Publication
(10) Pub. No.: US 2016/0075876 A1
(43) Pub. Date: Mar. 17, 2016

(54) Polyarylene ether sulfone (PAES) compositions

(71) Applicant: SOLVAY SPECIALTY POLYMERS USA, LLC, Alpharetta, GA (US)

(72) Inventors: Mohammad Jamal EL-HIBRI, Atlanta, GA (US); Chantal LOUIS, Alpharetta, GA (US); David B. THOMAS, Atlanta, GA (US); Hemantkumar PATEL, Alpharetta, GA (US)

(73) Assignee: SOLVAY SPECIALTY POLYMERS USA, LLC, Alpharetta, GA (US)

(21) Appl. No.: 14/889,659

(22) PCT Filed: Apr. 30, 2014
(86) PCT No.: PCT/EP2014/058803

§ 371 Date: Nov. 6, 2015

Related U.S. Application Data
(60) Provisional application No. 61/820,866, filed on May 8, 2013.

(30) Foreign Application Priority Data
Jul. 26, 2013 (EP) 13178122.1

(51) Int. Cl. C08L 81/06

(52) U.S. Cl. CPC C08L 81/06

(57) ABSTRACT

A composition [composition (C), herein after] comprising from 30 to 95% by weight of at least one poly(arylether sulfone) polymer, wherein said polymer comprising more than 50% moles of recurring units (Rₜ) of formula (Sₜ): -E-Ar¹—SO₂—[Ar²-(T-Ar³)ₙ—SO₂]ₘ—Ar⁴-(formula S) wherein n and m, equal to or different from each other, are independently zero or an integer of 1 to 5, each of Ar¹, Ar², Ar³ and Ar⁴ equal to or different from each other and at each occurrence, is an aromatic moiety, T is a bond or a divalent group optionally comprising one or more than one heteroatom;and E is of formula (Eₜ): herein each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; j′ is zero or is an integer from 1 to 4, from to 50% wt. of at least one reinforcing filler, and wherein all % wt. are based on the total weight of the composition (C).

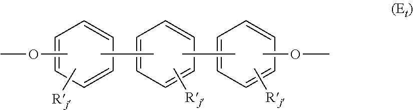

This application claims priority to U.S. provisional application No. 61/820866 filed on 8 May 2014 and to European application No. 13178122.1 filed on 26 Jul. 2013, the whole content of each of these applications being incorporated herein by reference for all purposes.

### FIELD OF INVENTION

The present invention relates to reinforced polyarylene ether sulfone (PAES) compositions comprising polymeric materials comprising moieties derived from incorporation of 4,4″-terphenyl-p-diol and to a process for the manufacture of said reinforced polyarylene ether sulfone (PAES) compositions.

### BACKGROUND OF THE INVENTION

The selection of polymeric material in more demanding, corrosive, harsh chemical, high-pressure and high-temperature (HP/HT) environments, such as notably in oil and gas downhole applications, in particular in deep see oil wells, is of ultimate importance as it implies that said polymeric materials need to possess some critical properties in order to resist the extreme conditions associated with said environments.

It should be mentioned that in these extreme conditions the polymeric materials are exposed in a prolonged fashion to high pressure, e.g. pressures higher than 30,000 psi, high temperatures e.g. temperatures up to 260° C., and to harsh chemicals including acids, bases, superheated water/steam, and of course a wide variety of aliphatic and aromatic organics. For example, enhanced oil recovery techniques involve injecting of fluids such as notably water, steam, hydrogen sulfide (H₂S) or supercritical carbon dioxide (sCO₂) into the well. In particular, sCO₂ having a solvating effect similar to n-heptane, can cause swelling of materials in for instance seals, which affect consequently their performance. Polymeric materials having too low glass transition temperatures (Tg) relative to the high temperature in HP/HT applications will suffer from being weak and susceptible to high creep in these HP/HT applications. This creep can cause the seal material made of said polymeric material to no longer effectively seal after prolonged exposure at temperature which are 20 or more ° C. above their Tg.

Thus, properties such as maintaining mechanical rigidity and integrity (e.g. yield/tensile strength, hardness and impact toughness) at high pressure and temperatures of at least 250° C., good chemical resistance, in particular when exposed to CO₂, H₂S, amines and other chemicals at said high pressure and temperature, swelling and shrinking by gas and by liquid absorption, decompression resistance in high pressure oil/gas systems, gas and liquid diffusion and long term thermal stability need to be considered in the selection of appropriate polymeric materials for HP/HT applications.

Thus said polymeric materials need at least to possess a high glass transition temperature.

The utility of aromatic sulfone ether polymers in applications combining high thermal and chemical exposure has been limited due to the fact that said aromatic sulfone ether polymers are large amorphous materials and are therefore very limited in their chemical resistance. Semi-crystalline aromatic sulfone ether polymers are extremely rare.

Staniland reports notably in Table 1 of Polymer Preprints, American Chemical Society, Division of Polymer Chemistry, 1992, 33(1), pages 404-405, some crystalline polyethersulphone polymers having high transition glass temperatures (Tg) of above 200° C. and having melting temperatures of below 400° C. (e.g. Structures 1-4 and 7). The author is in particular referring to the polyethersulphone polymer of structure 4 described therein (i.e. —OØØØOØSO₂Ø-, being understood that Ø is Ph or a phenyl group) derived from 4,4′ dichlorodiphenyl sulfone (DCDPS) and dihydroxyterphenylene, which has a Tg of 251° C. and a Tm of 359° C. Said polyethersulphone polymer of structure 4 was already earlier disclosed by the same author in Bulletin des Societes Chimiques Belges, 1989, 98 (9-10), pages 667-676. FIG. 6 of this paper shows notably a DSC (differential scanning calorimetry) scan of the polyethersulphone polymer of structure 4. Said polyethersulphone polymer has a 41% crystallinity when the crystallinity was measured on the powder obtained after isolation from the polymerization reactor. However, a crystallinity of a molded film of 38% could be regained when said molded film was annealed at 325° C.

Said polyethersulphone polymer of structure 4 also disclosed in EP 0 383 600 A2, in particular, examples 1 and 2 describe the reaction of dichlorodiphenylsulfone (DCDPS, e.g. example 1) or difluorodiphenylsulfone (DFDPS, e.g. example 2) with 4,4″-terphenyl-p-diol (i.e. HO-Ph-Ph-Ph-OH, also called 4,4″-dihydroxyterphenylene). Said aromatic polymers described in example 1, respectively example 2 have a high transition glass temperature (Tg) of 241° C., respectively 251° C., a Tm melting point of 385° C., respectively 389° C., a very high crystallinity of 44%, respectively 41%-44% and a reduced viscosity (RV) measured at 25° C. on a solution of 1.0 g of polymer in 100 cm³ H₂SO₄ of 0.27 (dL/g), respectively 1.40 (dL/g). As will be mentioned more in detail below, a RV of 1.40 (dL/g) corresponds with a Mn of about 10,000-11,000 for polyethersulphone polymer of structure 4 when measured by a GPC method as described below. It should be mentioned that the crystallinity, as described in EP 0 383 600 A2 refers to a crystallinity that has been measured on the powder obtained after isolation from the polymerization reactor.

It is known that thermosets due to their three dimensional network of bonds (i.e. cross-linking) are suitable to be used in high temperature applications up to the decomposition temperature However, one of the drawbacks is that they are more brittle.

In view of all the above, there is still a current shortfall in the art for compositions comprising polyarylene ether sulfone (PAES) polymers having improved tensile properties, in particular the elongation at break, relative to other prior art reinforced compositions and offers a much better retention of mechanical properties, in particular tensile and flexural strength and shear storage modulus, over the temperature range from room temperature to 250° C. and thus said compositions can be particularly useful HP/HT applications requiring a very good high temperature resistance.

### BRIEF DESCRIPTION OF DRAWINGS

FIG. 1 illustrates the comparison of the dynamic modulus (DMA modulus) as a function of temperature for unfilled HPHT polymer (C1, (t-PAES) polymer), un-reinforced PEEK polymer (C2), 20% Milled Glass Fiber (MGF) Reinforced HPHT (Example 3, composition (C) and 20% Milled Glass Fiber (MGF) Reinforced PEEK (C4).

### DETAILED DESCRIPTION OF THE PRESENT INVENTION

The Applicant has now found that it is possible to advantageously manufacture reinforced compositions comprising polyarylene ether sulfone (PAES) polymers wherein said (PAES) polymers comprise moieties derived from incorporation of 4,4″-terphenyl-p-diol and are advantageously fulfilling all the above mentioned needs, especially maintaining mechanical rigidity and integrity at high pressure and temperature. Said reinforced compositions allows the manufacturing of articles having improved resistant to deformations subjected to thermal cycling over a wide temperature range.

It is thus an object of the present invention, a composition [composition (C), herein after] comprising:
from 30 to 95% by weight [% wt., herein after] of at least one poly(arylether sulfone) polymer [(t-PAES) polymer], wherein said (t-PAES) polymer comprising more than 50% moles of recurring units (Rₜ) of formula (Sₜ):

-E-Ar¹—SO₂—[Ar²-(T-Ar³)ₙ—SO₂]ₘ—Ar⁴— (formula Sₜ)

wherein:
n and m, equal to or different from each other, are independently zero or an integer of 1 to 5,
each of Ar¹, Ar², Ar³ and Ar⁴ equal to or different from each other and at each occurrence, is an aromatic moiety,
T is a bond or a divalent group optionally comprising one or more than one heteroatom; preferably T is selected from the group consisting of a bond, —CH₂—, —C(O)—, —C(CH₃)₂—, —C(CF₃)₂—, —C(═CCl₂)—, —C(CH₃)(CH₂CH₂COOH)—, and a group of formula:

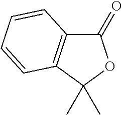

E is of formula (Eₜ):

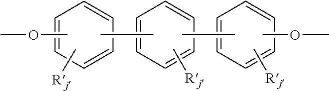

wherein
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
j′ is zero or is an integer from 1 to 4,
from 5 to 50% wt. of at least one reinforcing filler, and wherein all % wt. are based on the total weight of the composition (C).

The Applicant has surprisingly found that the t-PAES) polymer, as mentioned above, is effective in providing reinforced compositions possessing improved tensile properties, in particular the elongation at break while retaining mechanical properties, in particular tensile and flexural strength and shear storage modulus, after thermal treatment at high temperature.

The (t-PAES) Polymer

The aromatic moiety in each of Ar¹, Ar², Ar³ and Ar⁴ equal to or different from each other and at each occurrence is preferably complying with following formulae:

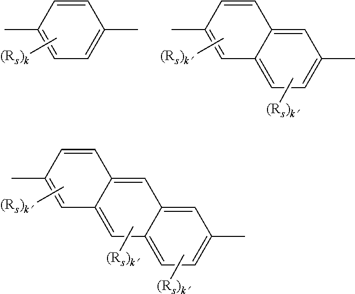

wherein:
each Rₛ is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
k is zero or an integer of 1 to 4; k′ is zero or an integer of 1 to 3.

In recurring unit (Rₜ), the respective phenylene moieties may independently have 1,2-, 1,4- or 1,3-linkages to the other moieties different from R or R′ in the recurring unit. Preferably, said phenylene moieties have 1,3- or 1,4-linkages, more preferably they have 1,4-linkage.

Still, in recurring units (Rₜ), j′, k′ and k are at each occurrence zero, that is to say that the phenylene moieties have no other substituents than those enabling linkage in the main chain of the polymer.

Preferred recurring units (Rₜ) are selected from the group consisting of those of formula (Sₜ-1) to (Sₜ-4) herein below:

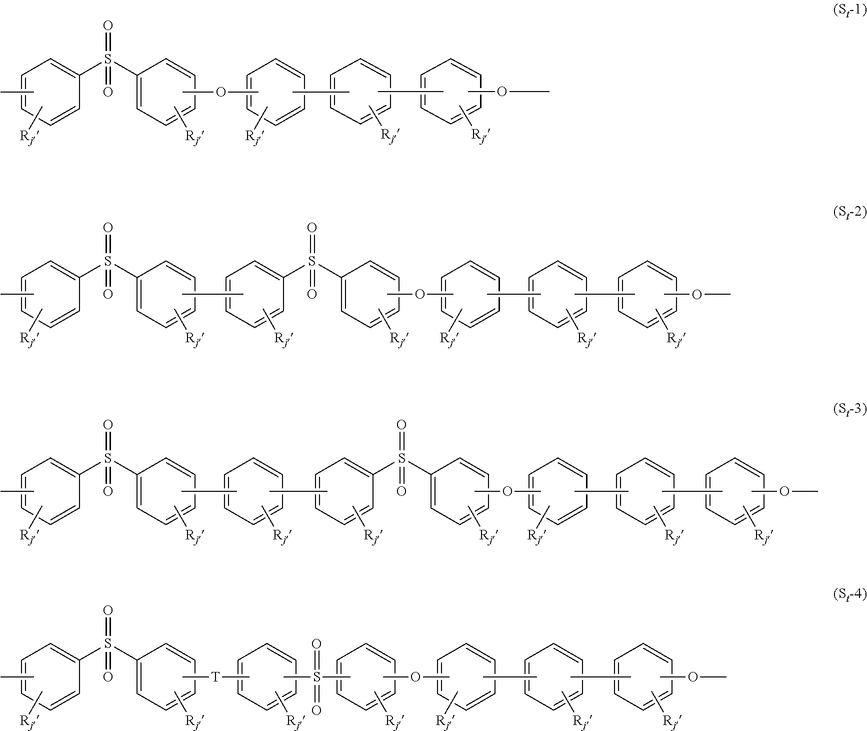

wherein
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
j′ is zero or is an integer from 1 to 4,
T is a bond or a divalent group optionally comprising one or more than one heteroatom; preferably T is selected from the group consisting of a bond, —CH₂—, —C(O)—, —C(CH₃)₂—, —C(CF₃)₂—, —C(═CCl₂)—, —C(CH₃)(CH₂CH₂COOH)—, and a group of formula:

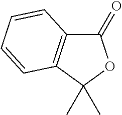

The above recurring units of preferred embodiments (Rₜ-1) to (Rₜ-4) can be each present alone or in admixture.

More preferred recurring units (Rₜ) are selected from the group consisting of those of formula (S′ₜ-1) to (S′ₜ-3) herein below:

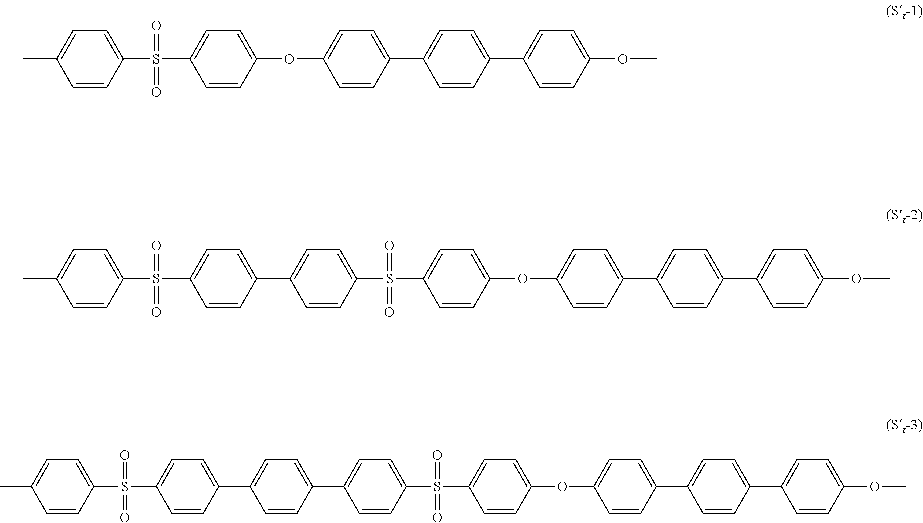

Most preferred recurring unit (Rₜ) is of formula (S′ₜ-1), as shown above. According to certain embodiments, the (t-PAES) polymer, as detailed above, comprises in addition to recurring units (Rₜ), as detailed above, recurring units (Rₐ) of formula (Kₐ):

-E-Ar⁵—CO—[Ar⁶-(T-Ar⁷)ₙ—CO]ₘ—Ar⁸— (formula Kₐ)

wherein:
n and m, equal to or different from each other, are independently zero or an integer of 1 to 5,
each of Ar⁵, Ar⁶, Ar⁷ and Ar⁸ equal to or different from each other and at each occurrence, is an aromatic moiety,
T is a bond or a divalent group optionally comprising one or more than one heteroatom; preferably T is selected from the group consisting of a bond, —CH₂—, —C(O)—, —C(CH₃)₂—, —C(CF₃)₂—, —C(═CCl₂)—, —C(CH₃)(CH₂CH₂COOH)—, and a group of formula:

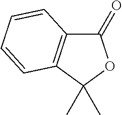

E is of formula (Eₜ), as detailed above.

Recurring units (Rₐ) can notably be selected from the group consisting of those of formulae (Kₐ-1) or (Kₐ-2) herein below:

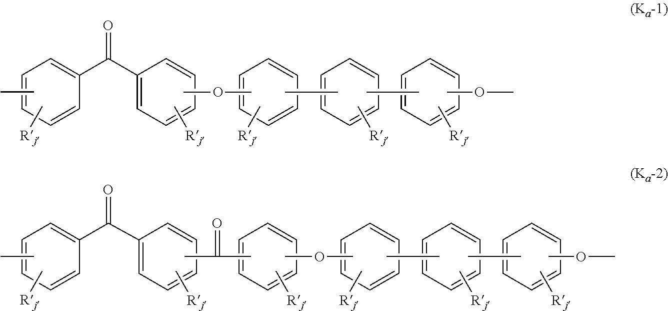

wherein
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
j′ is zero or is an integer from 1 to 4.

More preferred recurring units (Rₐ) are selected from the group consisting of those of formula (K′ₐ-1) or (K′ₐ-2) herein below:

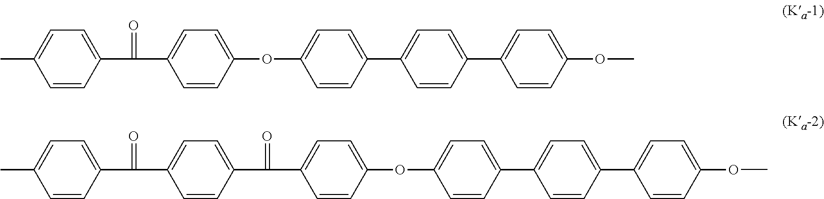

According to certain embodiments, the (t-PAES) polymer, as detailed above, comprises in addition to recurring units (Rₜ), as detailed above, recurring units (R_{b}) comprising a Ar—SO₂—Ar′ group, with Ar and Ar′, equal to or different from each other, being aromatic groups, said recurring units (R_{b}) generally complying with formulae (S1):

—Ar⁹-(T′-Ar¹⁰)ₙ—O—Ar¹¹—SO₂—[Ar¹²-(T-Ar¹³)ₙ—SO₂]ₘ—Ar¹⁴—O— (S1)

wherein:
Ar⁹, Ar¹⁰, Ar¹¹, Ar¹², Ar¹³ and Ar¹⁴, equal to or different from each other and at each occurrence, are independently a aromatic mono- or polynuclear group;
   T and T′, equal to or different from each other and at each occurrence, is independently a bond or a divalent group optionally comprising one or more than one heteroatom; preferably T′ is selected from the group consisting of a bond, —CH₂—, —C(O)—, —C(CH₃)₂—, —C(CF₃)₂—, —C(═CCl₂)—, —C(CH₃)(CH₂CH₂COOH)—, —SO₂—, and a group of formula:

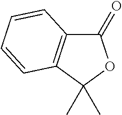

preferably T is selected from the group consisting of a bond, —CH₂—, —C(O)—, —C(CH₃)₂—, —C(CF₃)₂—, —C(═CCl₂)—, —C(CH₃)(CH₂CH₂COOH)—, and a group of formula:

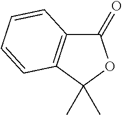

n and m, equal to or different from each other, are independently zero or an integer of 1 to 5;

Recurring units (R_{b}) can be notably selected from the group consisting of those of formulae (S1-A) to (S1-D) herein below:

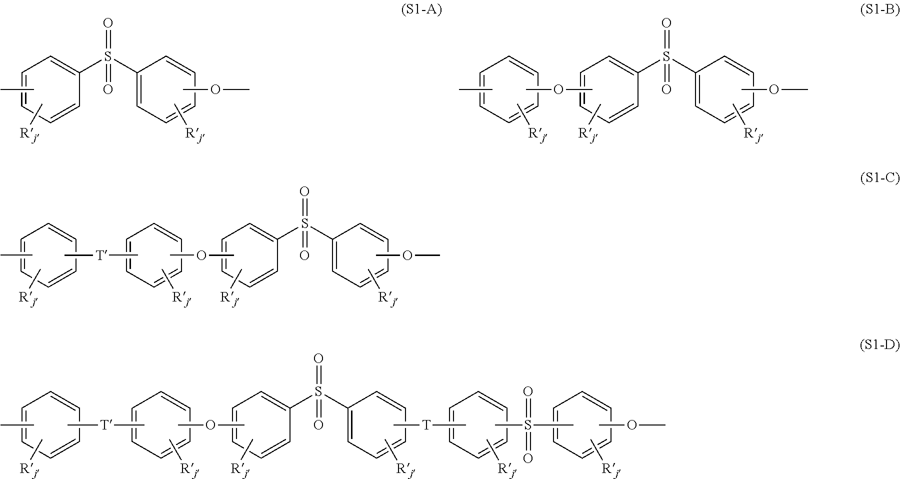

wherein:
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
j′ is zero or is an integer from 0 to 4;
T and T′, equal to or different from each other are a bond or a divalent group optionally comprising one or more than one heteroatom; preferably T′ is selected from the group consisting of a bond, —CH₂—, —C(O)—, —C(CH₃)₂—, —C(CF₃)₂—, —C(═CCl₂)—, —C(CH₃)(CH₂CH₂COOH)—, —SO₂—, and a group of formula:

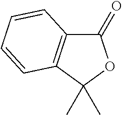

preferably T is selected from the group consisting of a bond, —CH₂—, —C(O)—, —C(CH₃)₂—, —C(CF₃)₂—, —C(═CCl₂)—, —C(CH₃)(CH₂CH₂COOH)—, and a group of formula:

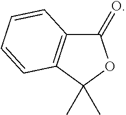

In recurring unit (R_{b}), the respective phenylene moieties may independently have 1,2-, 1,4- or 1,3-linkages to the other moieties different from R′ in the recurring unit. Preferably, said phenylene moieties have 1,3- or 1,4-linkages, more preferably they have 1,4-linkage. Still, in recurring units (R_{b}), j′ is at each occurrence zero, that is to say that the phenylene moieties have no other substituents than those enabling linkage in the main chain of the polymer.

According to certain embodiments, the (t-PAES) polymer, as detailed above, comprises in addition to recurring units (Rₜ), as detailed above, recurring units (R_{c}) comprising a Ar—C(O)—Ar′ group, with Ar and Ar′, equal to or different from each other, being aromatic groups, said recurring units (R_{c}) being generally selected from the group consisting of formulae (J-A) to (J-L), herein below:

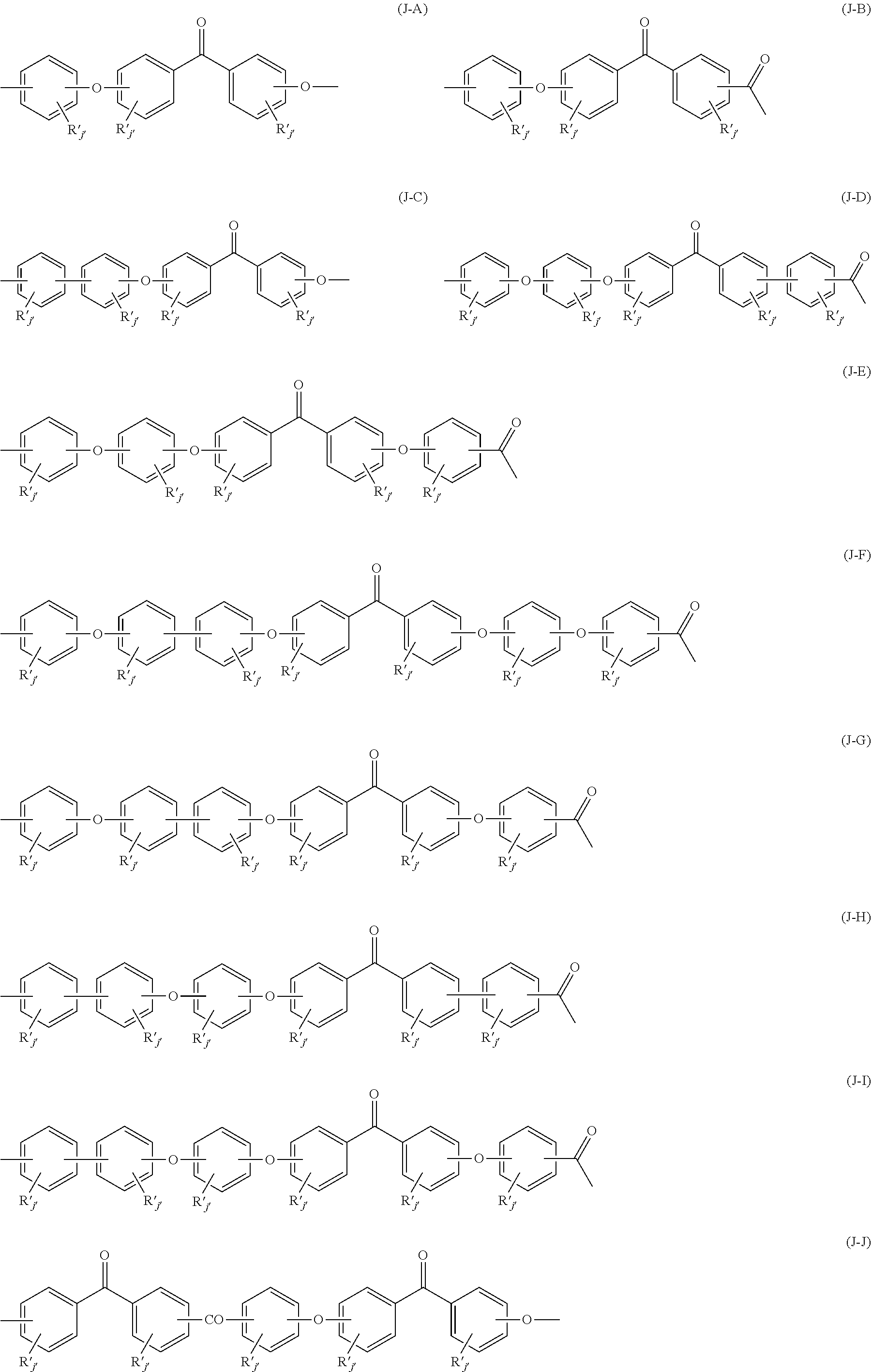

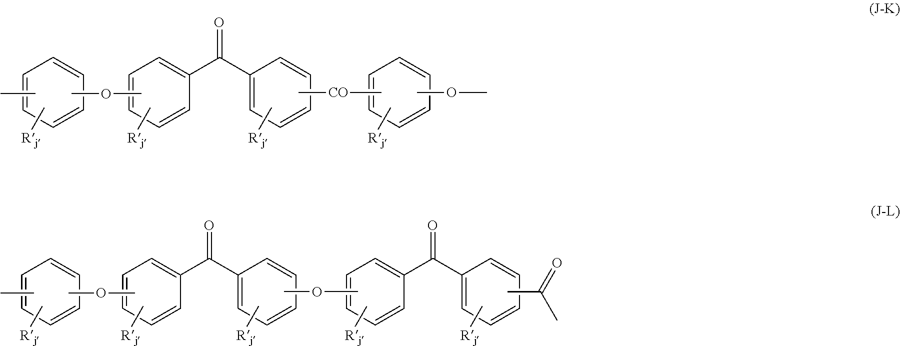

wherein:
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
j′ is zero or is an integer from 0 to 4.

In recurring unit (R_{c}), the respective phenylene moieties may independently have 1,2-, 1,4- or 1,3-linkages to the other moieties different from R′ in the recurring unit. Preferably, said phenylene moieties have 1,3- or or 1,4-linkages, more preferably they have 1,4-linkage.

Still, in recurring units (R_{c}), j′ is at each occurrence zero, that is to say that the phenylene moieties have no other substituents than those enabling linkage in the main chain of the polymer.

As said, the (t-PAES) polymer comprises recurring units (Rₜ) of formula (Sₜ) as above detailed in an amount of more than 50% moles, preferably more than 60% moles, more preferably more than 70% moles, even more preferably more than 80% moles, most preferably more than 90% moles, the complement to 100% moles being generally recurring units (Rₐ), as above detailed, and/or recurring units (R_{b}), and/or recurring units (R_{c}), as above detailed.

Still more preferably, essentially all the recurring units of the (t-PAES) polymer are recurring units (Rₜ), chain defects, or very minor amounts of other units might be present, being understood that these latter do not substantially modify the properties of the (t-PAES) polymer. Most preferably, all the recurring units of the (t-PAES) polymer are recurring units (Rₜ). Excellent results were obtained when the (t-PAES) polymer was a polymer of which all the recurring units are recurring units (Rₜ), as above detailed.

To the aim of providing polymers particularly suitable for being used in HP/HT applications, in particular in oil and gas downhole operations, the (t-PAES) polymer of the invention has advantageously a number average molecular weight (Mₙ) of at least 13 000, preferably at least 25 000, more preferably of at least 38 000.

Upper limit for the number average molecular weight (Mₙ) of the (t-PAES) polymer is not particularly critical and will be selected by the skilled in the art in view of final field of use.

In one embodiment of the present invention, the t-PAES polymer has advantageously a number average molecular weight (Mₙ) equal to or below 125 000, preferably equal to or below 95 000, preferably equal to or below 90 000, preferably equal to or below 80 000, preferably equal to or below 75 000, preferably equal to or below 70 000, preferably equal to or below 60 000, preferably equal to or below 56 000.

In one embodiment of the present invention, the t-PAES polymer has advantageously a number average molecular weight (Mₙ) in the range from 13 000 to 125 000, preferably ranging from 25 000 to 80 000, and preferably ranging from 38 000 to 80 000.

The (t-PAES) polymer having such specific molecular weight (Mₙ) range have been found to possess an excellent ductility (i.e. high tensile elongation), good thoughness while maintaining high Tg, and good crystallizability and good chemical resistance.

The expression “number average molecular weight (Mₙ)” is hereby used according to it usual meaning and mathematically expressed as:

$${M}_{n} = \frac{\sum {M}_{i} \cdot {N}_{i}}{\sum {N}_{i}}$$

wherein Mᵢ is the discrete value for the molecular weight of a polymer molecule, Nᵢ is the number of polymer molecules with molecular weight then the weight of all polymer molecules is Σ MᵢNᵢ and the total number of polymer molecules is Σ Nᵢ.
Mₙcan be suitably determined by gel-permeation chromatography (GPC), calibrated with polystyrene standards.

Other molecular parameters which can be notably determined by GPC are the weight average molecular weight (M_{w}):

$${M}_{w} = \frac{\sum {M}_{i}^{2} \cdot {N}_{i}}{\sum {M}_{i} \cdot {N}_{i}} ,$$

wherein Mᵢ is the discrete value for the molecular weight of a polymer molecule, Nᵢ is the number of polymer molecules with molecular weight then the weight of polymer molecules having a molecular weight Mᵢ is MᵢNᵢ.

For the purpose of the present invention, the polydispersity index (PDI) is hereby expressed as the ratio of weight average molecular weight (M_{w}) to number average molecular weight (Mₙ).

The details of the GPC measurement are described in detail in the method description given in the experimental section.

For the determination of the number average molecular weight (Mₙ) by GPC, the (t-PAES) polymer is generally dissolved in a solvent suitable for GPC providing hereby a polymer solution which can be injected into conventional GPC equipment.

The concentration of the (t-PAES) polymer in the polymer solution for the GPC measurement [polymer concentration, herein after] is between 1.0 to 10.0 mg/ml, preferably between 1.5 to 5.0 mg/ml, more preferably between 2.0 to 3.0 mg/ml. Good results were obtained with a concentration of the (t-PAES) polymer in the polymer solution of about 2.5 mg/ml.

Preferred solvents and solvent blends suitable to dissolve the (t-PAES) polymer of the present invention for determination of the Mₙ values are for example 4-chlorophenol, 2-chlorophenol, meta-cresol. 4-chlorophenol is most preferred.

The dissolving of the (t-PAES) polymer of the present invention is advantageously carried out at a temperature from 100 to 250° C., preferably from 120 to 220° C. and more preferably from 170 to 200° C.

For the determination of the Mₙ values by GPC, N-methyl-2-pyrrolidone (NMP) containing at least one salt is suitably used as eluent.

Suitable salts for use in NMP include lithium bromide and lithium chloride. Lithium bromide is most preferred.

The molar concentration of said salt present in NMP can vary from 0.05 mole salt per litre NMP to 0.2 mole salt per litre NMP. Good results were obtained when the molar concentration of said salt present in NMP is about 0.1 mole salt per litre NMP.

In a preferred embodiment, said polymer solution, before injecting into the GPC equipment, is further diluted by the eluent thereby providing a diluted polymer solution [polymer solution (2), herein after].

In this preferred embodiment, the concentration of the (t-PAES) polymer in the polymer solution (2) [polymer concentration (2), herein after] is between 0.05 to 0.50 mg/ml, preferably between 0.10 to 0.25 mg/ml, more preferably between 0.20 to 0.25 mg/ml. Good results were obtained with a concentration of the (t-PAES) polymer in the polymer solution (2) of about 0.25 mg/ml.

The GPC measurements are in general carried out at a temperature from 20 to 50° C., preferably from 30 to 50° C., more preferably from 35 to 45° C. Good results were obtained when the temperature was about 40° C.

The GPC measurements are in general carried out at a pump flow rate from 0.3 to 0.9 ml/min, preferably from 0.5 to 0.7ml/min. Good results were obtained when the flow rate was about 0.5 ml/min.

It is understood that the calibration with the polystyrene standards is carried out according to ordinary skills in the art. The details of said calibration with the polystyrene standards can be found in the experimental section below.

Another aspect of the present invention is related to the GPC measurement as described above.

The (t-PAES) polymer of the present invention has advantageously a polydispersity index (PDI) of more than 1.90, preferably more than 1.95, more preferably more than 2.00.

The (t-PAES) polymer of the present invention generally has a polydispersity index of less than 4.0, preferably of less than 3.8, more preferably of less than 3.5.

In addition, some other analytical methods can be used as an indirect method for the determination of molecular weight including notably viscosity measurements.

In addition, some other analytical methods can be used as an indirect method for the determination of molecular weight including notably viscosity measurements.

In one embodiment of the present invention, the (t-PAES) polymer of the present invention has a melt viscosity of advantageously at least 0.7 kPa·s, preferably at least 1.25 kPa·s, more preferably at least 2.3 kPa·s at 410° C. and at a shear rate of 10 rad/sec, as measured using a parallel plates viscometer (e.g. TA ARES RDA3 model) in accordance with ASTM D4440. The (t-PAES) polymer of the present invention has a melt viscosity of advantageously of at most 46 kPa·s, preferably of at most 34 kPa·s, more preferably of at most 25 kPa·s at 410° C. and at a shear rate of 10 rad/sec, as measured using a parallel plates viscometer (e.g. TA ARES RDA3 model) in accordance with ASTM D4440.

In another embodiment of the present invention, the (t-PAES) polymer of the present invention has a melt viscosity of advantageously at least 2.2 kPa·s, preferably at least 4.1 kPa·s, more preferably at least 7.4 kPa·s at 410° C. and at a shear rate of 1 rad/sec, as measured using a parallel plates viscometer e.g. (TA ARES RDA3 model) in accordance with ASTM D4440. The (t-PAES) polymer of the present invention has a melt viscosity of advantageously of at most 149 kPa·s, preferably of at most 111 kPa·s, more preferably of at most 82 kPa·s at 410° C. and at a shear rate of 1 rad/sec, as measured using a parallel plates viscometer (e.g. TA ARES RDA3 model) in accordance with ASTM D4440.

The (t-PAES) polymer of the present invention advantageously possesses a glass transition temperature of at least 210° C., preferably 220° C., more preferably at least 230° C.

Glass transition temperature (Tg) is generally determined by DSC, according to ASTM D3418.

The (t-PAES) polymer of the present invention advantageously possesses a melting temperature of at least 330° C., preferably 340° C., more preferably at least 350° C. The (t-PAES) polymer of the present invention advantageously possesses a melting temperature below 430° C., preferably below 420° C. and more preferably below 410° C.

The melting temperature (Tm) is generally determined by DSC, according to ASTM D3418.

The manufacturing of the (t-PAES) polymer of the present invention is not particularly limited. The (t-PAES) polymer can be prepared as notably described in EP 0 383 600 A2 or as notably described in our copending U.S. Provisional Patent Application.

The Applicant has found that the (t-PAES) polymer, as detailed above, is especially well suited for providing polymer compositions (C) which have an excellent balance of (1) stiffness and ductility, (2) crystallizability and chemical resistance (3) high thermal resistance (e.g. Tg>230° C.), long term thermal stability and adequate processability (e.g. Tm<420° C.).

In the polymer composition (C), the (t-PAES) polymer, as detailed above, is present in an amount of advantageously at least 35 wt. %, even more preferably at least 45 wt. %, still more preferably at least 55 wt. %, most preferably at least 70 wt. % based on the total weight of the polymer composition (C).

The (t-PAES) polymer, as detailed above, is also present in an amount of advantageously at most 95 wt. %, preferably at most 90 wt. %, more preferably at most 85 wt. %, still more preferably at most 82 wt. %, based on the total weight of the polymer composition (C).

Preferably, (t-PAES) polymer is present in an amount ranging from 35 to 90 wt. % and more preferably from 45 to 85 wt. %, based on the total weight of the polymer composition (C).

### Reinforcing Fillers

A large selection of reinforcing fillers may be added to the composition (C). They are preferably selected from fibrous and particulate fillers. A fibrous reinforcing filler is considered herein to be a material having length, width and thickness, wherein the average length is significantly larger than both the width and thickness. Generally, such a material has an aspect ratio, defined as the average ratio between the length and the largest of the width and thickness of at least 5. Preferably, the aspect ratio of the reinforcing fibers is at least 10, more preferably at least 20, still more preferably at least 50.

Preferably, the reinforcing filler is selected from mineral fillers, such as notably talc, mica, titanium dioxide, kaolin, calcium carbonate, calcium silicate, magnesium carbonate); glass fiber; carbon fibers such as notably graphitic carbon fibers (some of them having possibly a graphite content of above 99%), amorphous carbon fibers, pitch-based carbon fibers (some of them having possibly a graphite content of above 99%), PAN-based carbon fibers; synthetic polymeric fiber; aramid fiber; aluminum fiber; aluminum silicate fibers; oxide of metals of such aluminum fibers; titanium fiber; magnesium fiber; boron carbide fibers; rock wool fiber; steel fiber; asbestos; wollastonite; silicon carbide fibers; boron fibers, graphene, carbon nanotubes (CNT) and the like.

It is understood that the skilled person will easily recognize the reinforcing filler which fits best its composition and encompassed end uses. Generally, the reinforcing filler is chosen depending on its chemical nature, its length, diameter, ability to feed nicely in compounding equipment without bridging and surface treatment (notably because good interfacial adhesion between the reinforcing filler and the polymer improves the strength and the toughness of the blend.

In one embodiment, the filler is chosen from fibrous fillers. Preferably, the fibrous filler are glass fibers.

In other embodiment, the fillers are non-fibrous.

Glass fibers are silica-based glass compounds that contain several metal oxides which can be tailored to create different types of glass. The main oxide is silica in the form of silica sand; the other oxides such as calcium, sodium and aluminum are incorporated to reduce the melting temperature and impede crystallization. Glass fibers may have a round cross-section or a non-circular cross-section (so called “flat glass fibers”), including oval, elliptical or rectangular. The glass fibers may be added as endless fibers, as chopped glass fibers or as milled glass fibers. The glass fibers have generally an equivalent diameter of 5 to 20 preferably of 5 to 15 μm and more preferably of 5 to 10 μm. All glass fiber types, such as A, C, D, E, M, S, R, T glass fibers (as described in chapter 5.2.3, pages 43-48 of Additives for Plastics Handbook, 2nd ed, John Murphy), or any mixtures thereof or mixtures thereof may be used. For example, R, S and T glass fibers are high modulus glass fibers that have typically an elastic modulus of at least 76, preferably at least 78, more preferably at least 80, and most preferably at least 82 GPa as measured according to ASTM D2343.

E, R, S and T glass fibers are well known in the art. They are notably described in Fiberglass and Glass Technology, Wallenberger, Frederick T.; Bingham, Paul A. (Eds.), 2010, XIV, chapter 5, pages 197-225. R, S and T glass fibers are composed essentially of oxides of silicon, aluminum and magnesium. In particular, those glass fibers comprise typically from 62-75 wt. % of SiO₂, from 16-28 wt. % of Al₂O₃ and from 5-14 wt. % of MgO. To the contrary of the regular E-glass fibers widely used in polymer compositions, R, S and T glass fibers comprise less than 10 wt. % of CaO.

The fibrous filler, in particular the glass fiber, has a diameter preferably below 40 μm, more preferably, its diameter is below 20 μm, and still more preferably below 15 μm. On the other hand, the diameter of the fibrous filler, in particular the glass fiber, is preferably above 5 μm.

The fibrous filler, in particular the glass fiber, has a length preferably of below 20 mm, more preferably below 10 mm. Besides, it has a length of preferably above 1 mm, more preferably above 2 mm.

Preferably, the fibrous filler, in particular the glass fiber, is formulated with a high temperature sizing. The Applicant observed that said high temperature sizing provided superior interfacial adhesion with (t-PAES) polymer, as detailed above.

In a particular preferred embodiment, the fibrous filler is a milled glass fiber, especially suitable when the composition (C), as detailed above, is prepared by a method including a dry blending or slurry blending technique, as specified below.

Especially well-suited reinforcing fillers are Owens-Corning milled glass fiber, grade MF739DC and equivalents thereof.

In another embodiment, the reinforcing filler in the polymer composition (C) is a carbon fiber.

For the purpose of the present invention, the term “carbon fiber” is intended to include graphitized, partially graphitized and ungraphitized carbon reinforcing fibers or a mixture thereof.

For the purpose of the present invention, the term “fiber” means a fundamental form of solid (often crystalline) characterized by relative high tenacity and a high ratio of length to diameter.

The term “graphitized” intends to denote carbon fibers obtained by high temperature pyrolysis (over 2000° C.) of carbon fibers, wherein the carbon atoms place in a way similar to the graphite structure.

Carbon fibers useful for the present invention can advantageously be obtained by heat treatment and pyrolysis of different polymer precursors such as, for example, rayon, polyacrylonitrile (PAN), aromatic polyamide or phenolic resin; carbon fibers useful for the present invention may also be obtained from pitchy materials.

Carbon fibers useful for the present invention are preferably chosen from the group composed of PAN-based carbon fibers (PAN-CF), pitch based carbon fibers, graphitized pitch-based carbon fibers, and mixtures thereof.

PAN-based carbon fibers (PAN-CF) have advantageously a diameter of between 3 to 20 μm, preferably from 4 to 15 μm, more preferably from 5 to 10 μm, most preferably from 6 to 8 μm. Good results were obtained with PAN-based carbon fibers (PAN-CF) having a diameter of 7 μm.

The PAN-CF maybe of any length. In general, the length of PAN-CF is at least 50 μm.

Graphitized pitch-based carbon fibers are readily available from commercial sources containing at least about 50% weight graphitic carbon, greater than about 75% weight graphitic carbon, and up to substantially 100% graphitic carbon. Highly graphitic carbon fiber particularly suitable for use in the practice of this invention may be further characterized as highly conductive, and such fiber is generally used having a modulus of about 80 to about 120 million pounds per square inch, i.e., million lbs/in² (MSI). In certain embodiments the highly graphitic carbon fiber has a modulus of about 85 to about 120 MSI, and in other certain embodiments about 100 to about 115 MSI.

The pitch-based-CF has advantageously a diameter between 5 to 20 μm, preferably from 7 to 15 μm, more preferably from 8 to 12 μm.

The pitch-based-CF may be of any length. The pitch-based-CF has advantageously a length from 1 μm to 1 cm, preferably from 10 μm to 1 mm, more preferably from 25 μm to 500 μm and still more preferably from 50 to 250 μm.

Carbon fiber may be employed as chopped carbon fiber or in a particulate form such as may be obtained by milling or comminuting the fiber. Comminuted graphitized pitch-based carbon fiber suitable for use in the practice of the invention may be obtained from commercial sources including from Cytec Carbon Fibers as ThermalGraph DKD X and CKD X grades of pitch-based carbon fiber and Mitsubishi Carbon Fibers as Dialead carbon fibers. Chopped PAN-based carbon fibers preferably used in the present invention may be obtained from commercial sources.

In the polymer composition (C), the at least one reinforcing filler is present in an amount of advantageously at least 8 wt. %, preferably at least 10 wt. %, more preferably at least 15 wt. %, based on the total weight of the polymer composition (C).

The reinforcing filler is also present in an amount of advantageously at most 45 wt. %, more preferably at most 40 wt. %, still more preferably at most 30 wt. %, based on the total weight of the polymer composition (C).

### Other Ingredients

The polymer composition (C) may further optionally comprise other ingredients (I) such as a colorant such as notably a dye and/or a pigment such as notably titanium dioxide, zinc sulfide and zinc oxide, ultraviolet light stabilizers, heat stabilizers, antioxidants such as notably organic phosphites and phosphonites, acid scavengers, processing aids, nucleating agents, internal lubricants and/or external lubricants, flame retardants, a smoke-suppressing agents, an anti-static agents, anti-blocking agents, and/or conductivity additives such as carbon black and carbon nanofibrils.

The polymer composition (C) may also further comprise polytetrafluoroethylene (PTFE) or other fluoropolymers as friction reducing additives.

Their addition can be useful notably when the composition (C) must meet certain particular requirements, such as notably friction and wear requirements, as needed by certain special end uses, such as notably in uses where the functional part undergoes sliding friction under load.

When one or more other ingredients are present, their total weight, based on the total weight of polymer composition (C), is usually below 20%, preferably below 10%, more preferably below 5% and even more preferably below 2%.

The composition (C) of the invention is preferably consisting essentially of (t-PAES) polymer, as detailed above, the reinforcing filler, as detailed above, and optionally, other ingredients (I), as detailed above.

For the purpose of the present invention, the expression “consisting essentially of” are intended to denote that any additional ingredient different from (t-PAES) polymer, as detailed above, the reinforcing filler, as detailed above, and optionally, other ingredients (I), as detailed above is present in an amount of at most 1% by weight, based on the total weight of the composition (C).

In one preferred embodiment, the composition (C) of the invention comprises, preferably consists essentially of:
from 70 to 85 wt. % of the at least one (t-PAES) polymer,
from 15 to 30 wt. % of glass fibers
   and wherein all % are based on the total weight of the composition (C).

The composition (C) can be prepared by a variety of methods involving intimate admixing of the at least one (t-PAES) polymer, the reinforcing filler, as detailed above, and with any optional other ingredients (I), as detailed above, desired in the composition, for example by dry blending, suspension or slurry mixing, solution mixing, melt mixing or a combination of dry blending and melt mixing. Typically, the dry blending of (t-PAES) polymer, as detailed above, preferably in powder state, the reinforcing filler, as detailed above, and optionally, other ingredients (I) is carried out by using high intensity mixers, such as notably Henschel-type mixers and ribbon mixers so as to obtain a physical mixture, in particular a powder mixture.

Alternatively, the intimate admixing of the at least one (t-PAES) polymer, the reinforcing filler, as detailed above, and with any optional other ingredients (I), as detailed above, desired in the composition, is carried out by tumble blending based on a single axis or multi-axis rotating mechanism so as to obtain a physical mixture. In said tumble blending method, ceramic beads are typically used to advantageously impart greater intensity to the mixing process and to improve dispersion of the reinforcing filler.

Alternatively, the suspension or slurry mixing of the (t-PAES) polymer, as detailed above, the reinforcing filler, as detailed above, and optionally, other ingredients (I) is carried out by first slurrying said (t-PAES) polymer in powder form with the reinforcing filler and optionally, other ingredients (I) using an agitator in an appropriate liquid such as for example methanol, followed by filtering the liquid away, so as to obtain a powder mixture.

In another embodiment, the solution mixing of the (t-PAES) polymer, as detailed above, the reinforcing filler, as detailed above, and optionally, other ingredients (I) is carried out by dissolving said (t-PAES) polymer in powder form with the reinforcing filler and optionally, other ingredients (I) using an agitator in an appropriate solvent or solvent blends such as for example 4-chlorophenol, 2-chlorophenol, meta-cresol. 4-chlorophenol is most preferred.

Following the physical mixing step by one of the aforementioned techniques, the physical mixture, in particular the obtained powder mixture is typically melt fabricated by known methods in the art to form a semi-finished or finished part.

So obtained physical mixture, in particular the obtained powder mixture can comprise the (t-PAES) polymer, as detailed above, the reinforcing filler, as detailed above, and optionally, other ingredients (I) in the weight ratios as above detailed, suitable for obtaining shaped articles by melt fabrication processes such as compression molding, injection molding or extrusion, or can be a concentrated mixture to be used as masterbatch and diluted in further amounts of the (t-PAES) polymer, as detailed above, the reinforcing filler, as detailed above, and optionally, other ingredients (I) in subsequent processing steps. For example, the obtained physical mixture can be extruded into a stock shape like a slab or rod from which a final part can be machined. Alternatively, the physical mixture can be compression molded into a finished part or into a stock shape from which a finished part can be machined.

It is also possible to manufacture the composition of the invention by further melt compounding the powder mixture as above described. As said, melt compounding can be effected on the powder mixture as above detailed, or directly on the (t-PAES) polymer, as detailed above, the reinforcing filler, as detailed above, and optionally, other ingredients (I). Conventional melt compounding devices, such as co-rotating and counter-rotating extruders, single screw extruders, co-kneaders, disc-pack processors and various other types of extrusion equipment can be used. Preferably, extruders, more preferably twin screw extruders can be used.

If desired, the design of the compounding screw, e.g. flight pitch and width, clearance, length as well as operating conditions will be advantageously chosen so that sufficient heat and mechanical energy is provided to advantageously fully melt the powder mixture or the ingredients as above detailed and advantageously obtain a homogeneous distribution of the different ingredients. Provided that optimum mixing is achieved between the bulk polymer and filler contents. It is advantageously possible to obtain strand extrudates which are not ductile of the composition (C) of the invention. Such strand extrudates can be chopped by means e.g. of a rotating cutting knife after some cooling time on a conveyer with water spray. Thus, for example composition (C) which may be present in the form of pellets or beads can then be further used for the manufacture of articles.

Another aspect of the present invention is related to articles comprising the above described polymer composition (C).

The articles according to the present invention are made from the polymer composition (C) using any suitable melt-processing method. In particular, they are made by compression molding.

Should the disclosure of any patents, patent applications, and publications which are incorporated herein by reference conflict with the description of the present application to the extent that it may render a term unclear, the present description shall take precedence.

The invention will be now described in more details with reference to the following examples, whose purpose is merely illustrative and not intended to limit the scope of the invention.

### Raw Materials

1,1′:4′,1″-terphenyl-4,4″-diol commercially available from Yonghi Chemicals, China, further purified by washing with ethanol/water (90/10) at reflux. The purity of the resulting material was shown to be higher than 94.0% area as measured by Gas Chromatography, as detailed below.

4,4′-difluorodiphenylsulfone commercially available from Aldrich (99% grade, 99.32% measured) or from Marshallton (99.92% pure by GC).

Diphenyl sulfone (polymer grade) commercially available from Proviron (99.8% pure).

Potassium carbonate with a d₉₀<45 μm commercially available from Armand products.

Lithium chloride (99+%, ACS grade) commercially available from Acros.

KetaSpire® KT-820FP, a PEEK (Polyetheretherketone) fine powder with a maximum particle size defined by 100% passage through 104 mesh screen and a melt viscosity at 400° C. and 1000 s⁻¹ using ASTM D3835 in the range 0.38-0.50 kPa-s; commercially available from SOLVAY SPECIALTY POLYMERS USA, LLC.

Radel® R-5800P NT, a polyphenylsulfone (PPSU) fine powder produced from grinding pellets to a fine grind such that there is no retention on a 104 mesh screen; commercially available from SOLVAY SPECIALTY POLYMERS USA, LLC. Owens Corning Milled Glass Fiber, Grade: MF739DC 1/32″ purchased from Owens Corning Corporation

Media beads, made of high density zirconium oxide, and notably purchased from Glen Mills Inc.

### Procedure for the Preparation of a t-PAES Polymer

### COMPARATIVE EXAMPLE 1

In a 500 mL 4-neck reaction flask fitted with a stirrer, a N₂ inlet tube, a Claisen adapter with a thermocouple plunging in the reaction medium, and a Dean-Stark trap with a condenser and a dry ice trap were introduced 89.25 g of diphenyl sulfone, 28.853 g of a specific type of 1,1′:4′,1″-terphenyl-4,4″-diol and 27.968 g of 4,4′-difluorodiphenylsulfone (corresponding to a total % monomers of 38.9% and molar ratio dihalo (BB)/diol of 1.000). The flask content was evacuated under vacuum and then filled with high purity nitrogen (containing less than 10 ppm O₂). The reaction mixture was then placed under a constant nitrogen purge (60 mL/min). The reaction mixture was heated slowly to 220° C. At 220° C., 15.354 g of K₂CO₃ were added via a powder dispenser to the reaction mixture over 30 minutes. At the end of the addition, the reaction mixture was heated to 320° C. at 1° C./minute. After 13 minutes at 320° C., 1.119 g of 4,4′-difluorodiphenylsulfone were added to the reaction mixture while keeping a nitrogen purge on the reactor. After 2 minutes, 4.663 g of lithium chloride were added to the reaction mixture. 2 minutes later, another 0.280 g of 4,4′-difluorodiphenylsulfone were added to the reactor and the reaction mixture was kept at temperature for 5 minutes. The reactor content was then poured from the reactor into a stainless steel pan and cooled. The solid was broken up and ground in an attrition mill through a 2 mm screen. Diphenyl sulfone and salts were extracted from the mixture with acetone then water at pH between 1 and 12 then with acetone. The powder was then removed from the reactor and dried at 120° C. under vacuum for 12 hours yielding 44 g of a light brown powder. The powder was further ground subsequently in a lab-scale grinder to yield a fine powder with an average particle size of around 100 μm. The molecular weights of the final t-PAES polymer were measured by GPC, as detailed below and Mn was found to be 39,000 g/mole.

### General Description of the Compounding and Molding Process of Polymer Compositions

### EXAMPLE 3 AND COMPARATIVE EXAMPLES 4 AND 5

A small Ceramic jar mill from Fisher Scientific with a capacity of 100 grams was used to blend the corresponding polymer fine powder (the t-PAES polymer, the PEEK fine powder polymer and the PPSU fine powder polymer) with the milled glass fiber. Each blend was 50 grams total by weight which consisted of 80% polymer fine powder and 20% milled glass fiber (see Table 2, below). Eight grinding media beads 0.5 in diameter×0.5 in height were added to the jar to facilitate the blending and dispersion of the glass fiber in the polymer fine powder. The jar was tumbled, end over end, on a single axle rotator for an hour. After this blending step, the fine powder/milled glass fiber mixture was compression molded into 4 in×4 in×0.125 in plaques using a Fontijne programmable compression molding press according to the compression molding protocols as shown in Table 1.

TABLE 1
t-PAES polymer (Comparative example 1)

| | Pressure | Time | Heat | Cooling Control |
|---|---|---|---|---|
| Segment | (lbf 10²) | (hh.mm.ss) | (° F.) | Contacts) |
| 1 | 45 | 0:15:00 | 790 | |
| 2 | 45 | 0:00:01 | 790 | |
| 3 | 60 | 0:02:00 | 790 | |
| 4 | 60 | 0:00:01 | 790 | |
| 5 | 60 | 0:20:00 | 610 | |
| 6 | 60 | 0:00:01 | 610 | |
| 7 | 60 | 1:30:00 | 610 | |
| 8 | 60 | 0:00:01 | 610 | |
| 9 | 45 | 1:10:00 | 75 | Set @00 00 00 00 1, |
| | | | | Water |
| 10 | 45 | 0:00:20 | 75 | Set @00 00 00 01 0, |
| | | | | Air Purge |

PEEK polymer

| | Pressure | Time | Heat | Cooling Control |
|---|---|---|---|---|
| Segment | (lbf 102) | (hh.mm.ss) | (° F.) | Contacts) |
| 1 | 45 | 0:20:00 | 752 | |
| 2 | 45 | 0:00:01 | 752 | |
| 3 | 60 | 0:02:00 | 752 | |
| 4 | 60 | 0:00:01 | 752 | |
| 5 | 45 | 0:40:00 | 75 | Set @00 00 00 00 1, |
| | | | | Water |
| 6 | 45 | 0:00:20 | 75 | Set @00 00 00 01 0, |
| | | | | Air Purge |

PPSU polymer

| | Pressure | Time | Heat | Cooling Control |
|---|---|---|---|---|
| Segment | (lbf 102) | (hh.mm.ss) | (° F.) | Contacts) |
| 1 | 45 | 0:40:00 | 640 | |
| 2 | 45 | 0:00:01 | 640 | |
| 3 | 60 | 0:05:00 | 640 | |
| 4 | 60 | 0:00:01 | 640 | |
| 5 | 45 | 0:30:00 | 75 | Set @00 00 00 00 1, |
| | | | | Water |
| 6 | 45 | 0:00:20 | 75 | Set @00 00 00 01 0, |
| | | | | Air Purge |

The following characterizations carried out on the materials of the Examples are indicated hereinafter:

### Molecular Weight Measurements by a GPC Method

### GPC Condition:

Pump: 515 HPLC pump manufactured by Waters
Detector: UV 1050 series manufactured by HP
Software: Empower Pro manufactured by Waters
Injector: Waters 717 Plus Auto sampler
Flow rate: 0.5 ml/min
UV detection: 270 nm
Column temperature: 40° C.
Column: 2× PL Gel mixed D, 5 micron, 300 mm×7.5 mm 5 micron manufactured by Agilent
Injection: 20μ liter
Runtime: 60 minutes
Eluent: N-Methyl-2-pyrrolidone (Sigma-Aldrich, Chromasolv Plus for HPLC >99%) with 0.1 mol Lithium bromide (Fisher make). Mobile phase should be store under nitrogen or inert environment
Calibration standard: Polystyrene standards part number PL2010-0300 manufactured by Agilent was used for calibration. Each vial contains a mixture of four narrow polydispersity polystyrene standards (a total 11 standard, 371100, 238700, 91800, 46500, 24600, 10110, 4910, 2590, 1570, 780 used to establish calibration curve)
Concentration of standard: 1 milliliter of mobile phase added in to each vial before GPC injection for calibration.
Calibration Curve: 1) Type: Relative, Narrow Standard Calibration 2) Fit: 3^{rd} order regression.
Integration and calculation: Empower Pro GPC software manufactured by Waters used to acquire data, calibration and molecular weight calculation. Peak integration start and end points are manually determined from significant difference on global baseline.
Sample Preparation: 25 mg of the (t-PAES) polymer was dissolved in 10 ml of 4-chlorophenol upon heating at 170 to 200° C. A small amount (0.2 to 0.4 ml) of said solution obtained was diluted with 4 ml of N-Methyl-2-pyrrolidone. The resulting solution was passed through to GPC column according to the GPC conditions mentioned above.

### Mechanical Property Measurements

The 4 in∴4 in×0.125 in compression molded plaques of all the polymer compositions (as detailed above and in Table 2) were machined into Type V ASTM tensile specimens and 0.5 in wide flexural specimens and these specimens of the various polymer compositions were subjected to tensile testing according to ASTM method D638 and flexural testing according ASTM method D790. Tensile testing and flexural testing were conducted both at room temperature (i.e. 23° C.) and at 200° C.

### Dynamic Mechanical Analysis (DMA) Measurements of the Molded Plaques

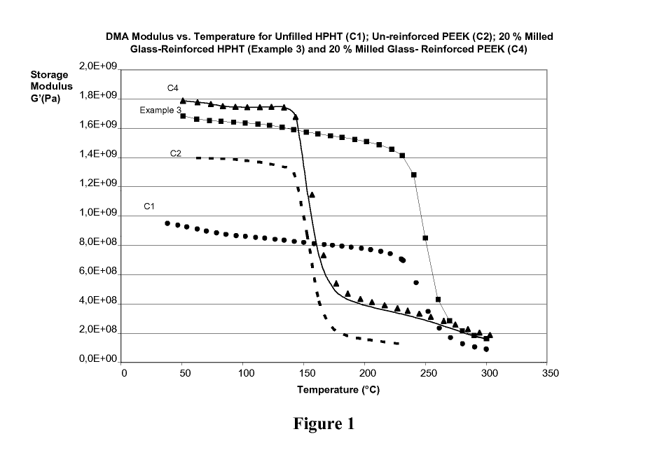

Rectangular test samples (1.2 cm×5.1 cm) were prepared from these molded plaques and were dried at 120° C. under vacuum for 12 hours. Said test samples were then analyzed by Dynamic Mechanical Analysis (DMA) on an TA ARES G2 rheometer under torsion mode (10 rad/sec, 0.05% strain) from 50 to 330° C. at 5.0° C./min, in order to measure the storage modulus (G′, Pa) at different temperatures, ranging from about 50° C. up to 310° C. The data are presented in FIG. 1. FIG. 1 compares the dynamic modulus as a function of temperature for unfilled HPHT polymer (C1, (t-PAES) polymer), un-reinforced PEEK polymer (C2), 20% Milled Glass Fiber (MGF) Reinforced HPHT (Example 3, composition (C) and 20% Milled Glass Fiber (MGF) Reinforced PEEK (C4). The Applicant has surprisingly found that the addition of 20% Milled Glass Fiber (MGF) to the (t-PAES) polymer, in particular polyterphenylsulfone (HPHT) polymer (C1) providing hereby example 3, allows a high increase of the shear storage modulus (G′, Pa) (i.e. roughly a doubling of said shear storage modulus) over the temperature range from room temperature up to the glass transition temperature of t-PAES, while the effect of MGF reinforcement on the PEEK modulus over a wide range of temperature is much more limited. In particular, example 3 shows a dramatic boost in thermal performance over C4, where the shear storage modulus (G′, Pa) is retained at a high level up to a temperature of about 250° C. for example 3 as compared to about 150° C. for comparative example C4.

TABLE 2

| | | | Polymer | | |
|---|---|---|---|---|---|
| | Polymers | | compositions | | |
| Examples (Ex.) | C1 | C2 | 3 | C4 | C5 |
| (t-PAES) polymer (wt %) | 100 | | 80 | | |
| Radel ® R-5800P NT fine | | | | | 80 |
| powder PPSU polymer (wt %) | | | | | |
| KetaSpire ® KT-820FP PEEK | | 100 | | 80 | |
| fine powder polymer - (wt %) | | | | | |
| Owens Corning Milled Glass Fiber, | | | 20 | 20 | 20 |
| Grade: MF739DC 1/32″ (wt %) | | | | | |
| Mechanical properties at 23° C. | | | | | |
| Tensile Elongation at Break (%) | 8.7 | 17.6 | 7.6 | 6.3 | — |
| Tensile Strength at Yield (psi) | 11100 | 14900 | 9200 | 12400 | 9250 |
| (speed 0.05 in/min) [Tens. S23] | | | | | |
| Flex Strength (psi) [Flex. S23] | — | — | 16900 | 23500 | — |
| Flex Modulus (ksi) [Flex. M23] | — | — | 583 | 890 | |
| Mechanical properties at 200° C. | | | | | |
| Tensile Strength at Yield (psi) | 9130 | 5020 | 9165 | 7100 | — |
| (speed 0.05 in/min) [Tens. S200] | | | | | |
| Flex Strength (psi) [Flex. S200] | — | — | 11400 | 5270 | |
| Flex Modulus (ksi) [Flex. M200] | — | — | 508 | 170 | |
| Percent Reduction of mechanical | | | | | |
| properties over temperature | | | | | |
| range from 23° C. to 200° C.^{(a)} | | | | | |
| {([Tens. S23] − [Tens. | 17.7 | 66.3 | 0.4 | 42.7 | — |
| S200])/[Tens. S23]} × 100% | | | | | |
| {([Flex. S23] − [Flex. | — | — | 32.5 | 77.6 | — |
| S200])/[Flex. S23]} × 100% | | | | | |
| {([Flex. M23] − [Flex. | — | — | 12.9 | 80.9 | |
| M200])/[Flex. M23]} × 100% | | | | | |

^{(a)}the lower the percentage, the better the retention of mechanical properties, thus Example 3, composition (C) of the present invention clearly retains much better its mechanical properties upon increasing the temperature.

1-12. (canceled)

13. A composition, composition (C), comprising:
from 30 to 95 % wt. of at least one poly(arylether sulfone) polymer, (t-PAES) polymer, wherein said (t-PAES) polymer comprises more than 50 % moles of recurring units (Rₜ) of formula (Sₜ):
-E-Ar¹—SO₂—[Ar²-(T-Ar³)ₙ—SO₂]ₘ—Ar⁴— (formula Sₜ)
wherein:
n and m, equal to or different from each other, are independently zero or an integer of 1 to 5;
each of Ar¹, Ar², Ar³ and Ar⁴ equal to or different from each other and at each occurrence, is an aromatic moiety;
T is a bond or a divalent group optionally comprising one or more than one heteroatom
E is of formula (Eₜ): 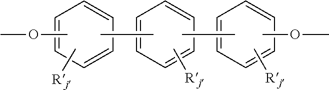
wherein:
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
j′ is zero or is an integer from 1 to 4;
from 5 to 50 % wt. of at least one reinforcing filler;
and wherein all % wt. are based on the total weight of the composition (C).

14. The composition (C) according to claim 13, wherein said recurring units (Rₜ) are selected from the group consisting of formula (Sₜ-1) to (Sₜ-4): 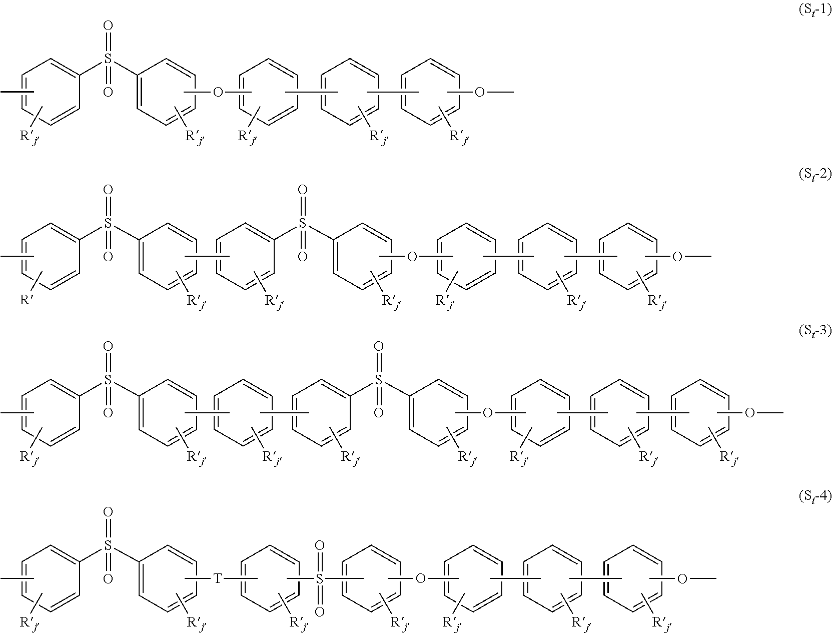
wherein:
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
j′ is zero or is an integer from 1 to 4; and
T is a bond or a divalent group optionally comprising one or more than one heteroatom.

15. The composition (C) according to claim 13, wherein said (t-PAES) polymer additionally comprises recurring units (Rₐ) of formula (Kₐ):
-E-Ar⁵—CO—[Ar⁶-(T-Ar⁷)ₙ—CO]ₘ—Ar⁸— (formula Kₐ)
wherein:
n and m, equal to or different from each other, are independently zero or an integer of 1 to 5;
each of Ar⁵, Ar⁶, Ar⁷ and Ar⁸ equal to or different from each other and at each occurrence, is an aromatic moiety;
T is a bond or a divalent group optionally comprising one or more than one heteroatom;
E is of formula (Eₜ): 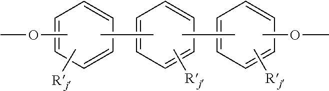
wherein:
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium.

16. The composition (C) according to claim 13, wherein said (t-PAES) polymer additionally comprises recurring units (R_{b}) comprising a Ar—SO₂—Ar′ group, with Ar and Ar′, equal to or different from each other, are aromatic groups, said recurring units (R_{b}) complying with formulae (S1):
—Ar⁹-(T′-Ar¹⁰)ₙ—O—Ar¹¹—SO₂—[Ar¹²-(T-Ar¹³)ₙ—SO₂]ₘ—Ar¹⁴—O— (S1)
wherein:
Ar⁹, Ar¹⁰, Ar¹¹, Ar¹², Ar¹³ and Ar¹⁴, equal to or different from each other and at each occurrence, are independently an aromatic mono- or polynuclear group;
T and T′, equal to or different from each other and at each occurrence, is independently a bond or a divalent group optionally comprising one or more than one heteroatom; and
n and m, equal to or different from each other, are independently zero or an integer of 1 to 5.

17. The composition (C) according to claim 13, wherein said (t-PAES) polymer additionally comprises recurring units (R_{c}) comprising a Ar—C(O)—Ar′ group, with Ar and Ar′, equal to or different from each other, are aromatic groups, said recurring units (R_{c}) are selected from the group consisting of formulae (J-A) to (J-L): 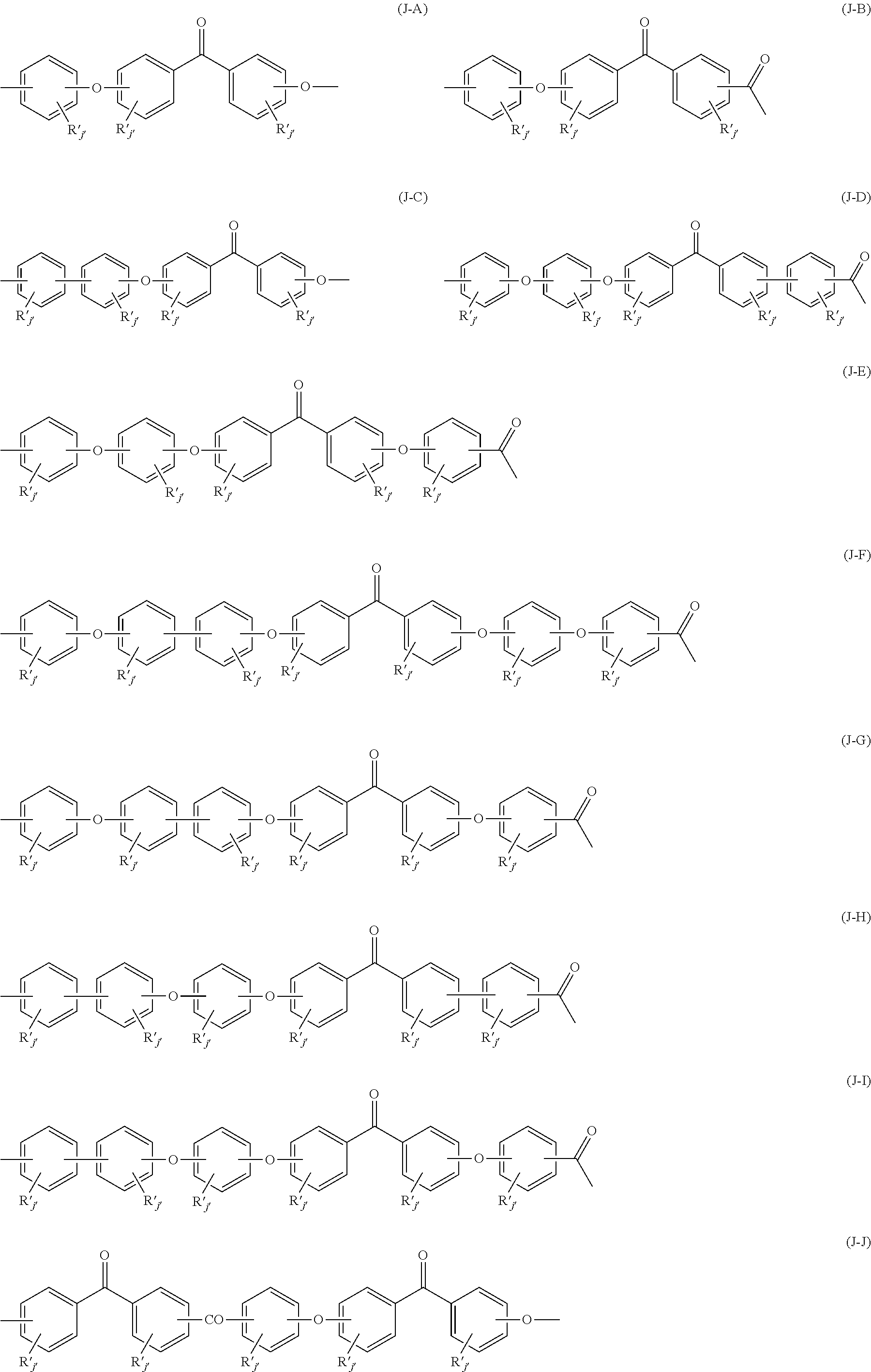 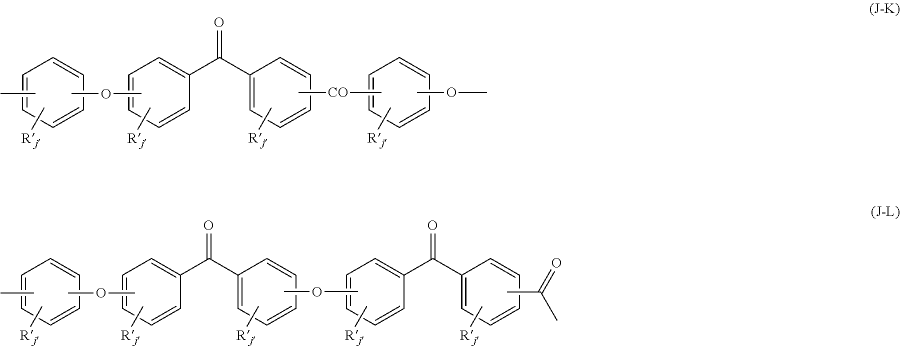
wherein:
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
j′ is zero or is an integer from 0 to 4.

18. The composition (C) according to claim 13, wherein the (t-PAES) polymer has a number average molecular weight (Mₙ) of at least 13,000.

19. The composition (C) according to claim 13, wherein the reinforcing filler is a fibrous filler.

20. The composition (C) according to claim 13, further comprising other ingredients (I) in an amount below 20 % wt. based on the total weight of polymer composition (C).

21. A process for manufacturing the composition (C) according to claim 13, the process comprises mixing:
at least one (t-PAES) polymer;
at least one reinforcing filler, and optionally other ingredients (I).

22. The process according to claim 21, wherein the mixing is carried out by dry blending, slurry mixing, solution mixing, melt mixing, or a combination of dry blending and melt mixing.

23. A method of manufacturing an article according to claim 24, wherein the article is manufactured by at least one melt-processing method.

24. An article comprising the polymer composition (C) according to claim 13.

25. The composition (C) according to claim 13, wherein T is selected from the group consisting of a bond, —CH₂—, —C(O)—, —C(CH₃)₂—, —C(CF₃)₂—, —C(═CCl₂)—, —C(CH₃)(CH₂CH₂COOH)—, and a group of formula:

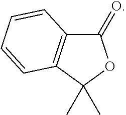

26. The composition (C) according to claim 16, wherein T′ is selected from the group consisting of a bond, —CH₂—, —C(O)—, —C(CH₃)₂—, —C(CF₃)₂—, —C(═CCl₂)—, —C(CH₃)(CH₂CH₂COOH)—, —SO₂—, and a group of formula:

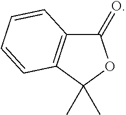

27. The composition (C) according to claim 19, wherein the fibrous filler is glass fiber.
